(19) United States
(12) Patent Application Publication
(10) Pub. No.: US 2025/0328566 A1
(43) Pub. Date: Oct. 23, 2025

(54) CACHE REPLACEMENT FOR TEXT DATA USING SEMANTIC DIVERSITY

(71) Applicant: Cisco Technology, Inc., San Jose, CA (US)

(72) Inventors: Arun Kwangil Iyengar, Yorktown Heights, NY (US); Ashish Kundu, Milpitas, CA (US)

(73) Assignee: Cisco Technology, Inc., San Jose, CA (US)

(21) Appl. No.: 18/642,227

(22) Filed: Apr. 22, 2024

(51) Int. Cl. G06F 16/33; G06F 12/0802; G06F 16/383

(52) U.S. Cl. CPC G06F 16/3344; G06F 12/0802; G06F 16/383

(57) ABSTRACT

In one implementation, a device stores a plurality of query-response pairs of queries issued to a language model and their corresponding answers from the language model in a cache. The device determines that the cache should be pruned based on a size of the cache exceeding a threshold size. The device selects a particular query-response pair from amongst the query-response pairs based on that pair having a minimal semantic distance to another query-response pair in the plurality of query-response pairs. The device prunes the particular query-response pair from the cache.

### TECHNICAL FIELD

The present disclosure relates generally to cache replacement for text data using semantic diversity.

### BACKGROUND

The recent breakthroughs in Large Language Models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

Recently, efforts have shifted towards augmenting an LLM system with a caching mechanism that allows the system to first search a cache of existing question-answer pairs, only querying the LLM for answers to questions that do not match (or are sufficiently similar to) those questions stored in the cache. Doing so can significantly reduce the costs associated with querying the LLM. However, simply caching the answers to every question sent to the LLM would also cause the cache to grow to an unwieldy size over time, thereby taking up a considerable amount of memory. In addition, the larger the cache, the greater the latency in performing a search of the cache.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for a large language model (LLM)-based agent for LLM-cache replacement using semantic diversity;

FIG. 4 illustrates an example of the interactions of the components of the architecture in FIG. 3;

FIG. 5 illustrates an example operating environment for cache replacement for text data using semantic diversity; and

FIG. 6 illustrates an example simplified procedure for cache replacement for text data using semantic diversity.

### DESCRIPTION OF EXAMPLE IMPLEMENTATIONS

### Overview

According to one or more implementations of the disclosure, a device stores a plurality of query-response pairs of queries issued to a language model and their corresponding answers from the language model in a cache. The device determines that the cache should be pruned based on a size of the cache exceeding a threshold size. The device selects a particular query-response pair from amongst the query-response pairs based on that pair having a minimal semantic distance to another query-response pair in the plurality of query-response pairs. The device prunes the particular query-response pair from the cache.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

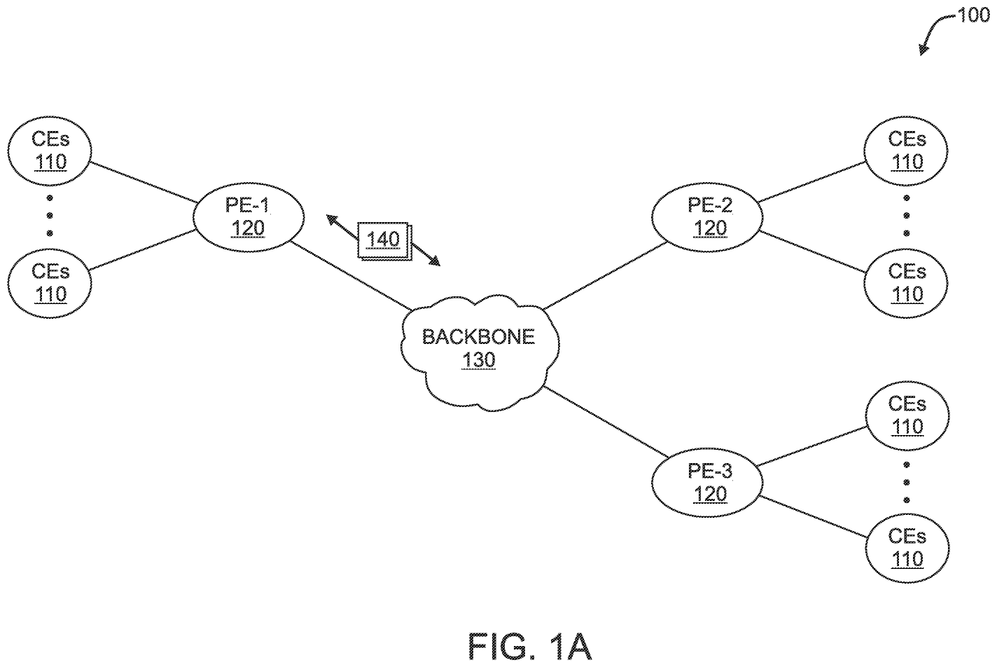

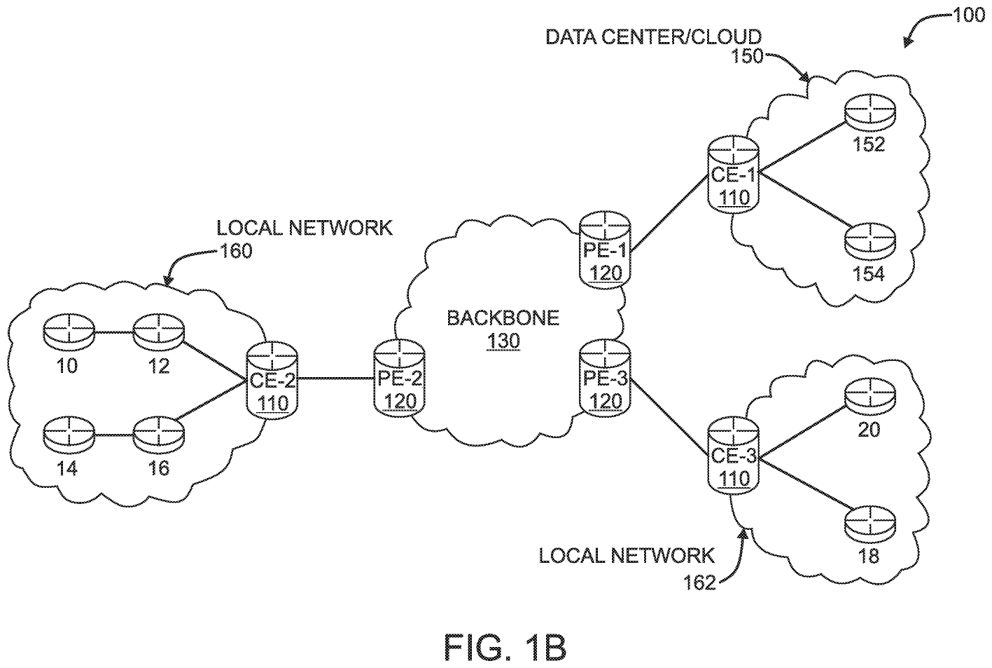

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

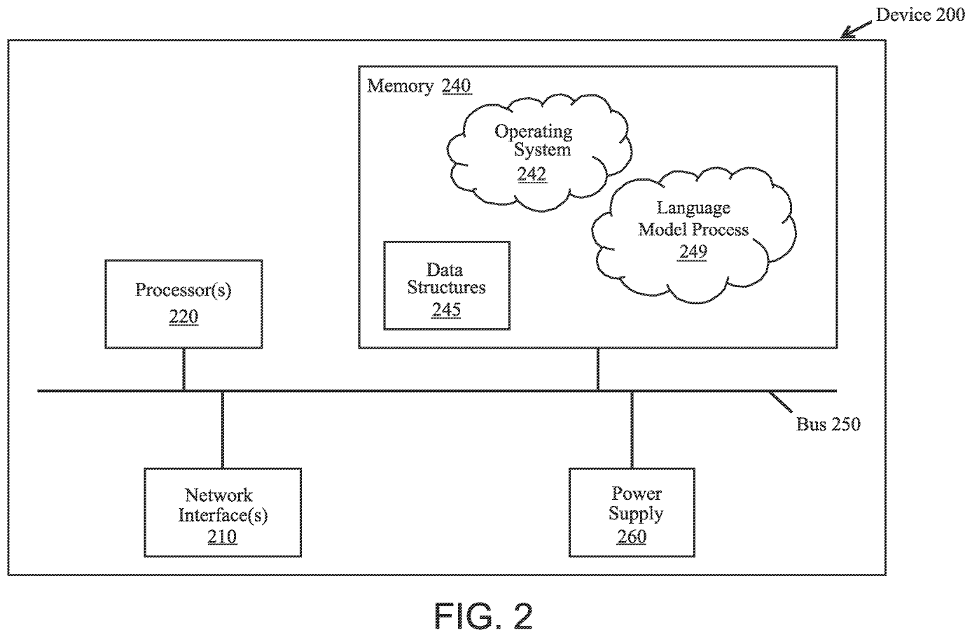

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, language model process 249 may include computer executable instructions that, when executed by processor(s) 220, cause device 200 to perform the techniques described herein. To do so, in some implementations, language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, generative AI systems like ChatGPT and Google Bard can have high latency. If many queries are being made, the overhead and time delay for responses can be considerable. Caching the results of queries can improve performance considerably. It can also reduce monetary costs for LLM queries, as well as reduce computational costs on servers providing LLM content.

One example issue when implementing such a caching mechanism relates to the challenges in determining what content to keep in the cache. Indeed, caches typically have a maximum size due to hardware and/or software constraints. Further, overhead for cache operations can grow with the number of objects in a cache. Traditional caches typically use hash tables for cache directories; determining whether an object is in a cache requires an expected running time which is does not appreciably increase with the number of cached objects. However, caches for storing the results of natural language queries preferably use semantic similarity techniques to function effectively. Determining whether a cache hit has occurred becomes more complicated than using a hash table. The overhead can grow with the number of cached natural language queries.

To address the above issues, cache replacement is often used whereby cache entries are not stored indefinitely but are potentially replaced over time. Typically, this is done using a Least Recently Used (LRU) approach in which the cache entry that has gone the longest without being accessed is the next eligible for replacement.

In the specific context of caching query-response pairs for a language model, the semantics of the queries themselves can also present certain challenges. Often, semantically similar queries can also be syntactically different. For example, consider the following queries:
“Explain how random forests can be used for regression and classification problems.”
“I need to perform regression and classification on certain data sets. I have heard that random forests are a potential approach. How can I apply random forests for what I am trying to do?”

While both of these queries are quite different from a syntactic standpoint, they also have very similar meanings and are effectively asking for the same answer. This means that one potential optimization of the cache would be to have a single cache entry that is capable of satisfying both of the above queries. However, the traditional approach would be to have separate query-answer entries in the cache for both of the above queries. However, when the cache is close to being full, different responses may not be desired for both of these queries. These different responses will take up valuable space in the cache when a single response could suffice for both requests. Therefore, a diversity of semantic content in the cache may be used to cover as wide a variety of responses as possible.

### Cache Replacement for Text Data Using Semantic Diversity

The techniques herein provide for the optimized management of a caching mechanism for text data, e.g., for a language model, such as an LLM or a set of LLMs. More specifically, the techniques herein allow for the replacement of cache entries based on their perceived utility, allowing for a more compact cache and reduced resource consumption. For instance, in some implementations, the cache replacement mechanism may seek to maximize the amount of semantic diversity among the queries stored in the cache.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein.

Specifically, according to various implementations, a device stores a plurality of query-response pairs of queries issued to a language model and their corresponding answers from the language model in a cache. The device determines that the cache should be pruned based on a size of the cache exceeding a threshold size. The device selects a particular query-response pair from amongst the plurality of query-response pairs based on that pair having a minimal semantic distance to another query-response pair in the plurality of query-response pairs. The device prunes the particular query-response pair from the cache.

Operationally, the disclosure provides techniques for increasing diversity of content in the LLM cache. A diversity of semantic content in the cache may improve cache hit rates. Stated alternatively, if semantically similar content is stored in the cache, the cache hit rate may be lower. The diversity of content in the cache is improved by being selective in determining responses to be removed from the cache when the cache becomes full or near full. In one example, therefore, a preference is given to remove responses that are semantically similar to other responses stored in the cache. Conversely, a preference is given to retaining responses in the cache that are semantically different from other responses.

For a cached response r, let d be defined as a minimum semantic distance between the query corresponding to r and another query corresponding to a response in the cache. The larger the value of d, the higher the desirability of caching response r. It should be noted that there are other criteria/parameters besides diversity of content that may be considered for cache replacement. These parameters include, but are not limited to:
Frequency of access, f: more frequently requested responses are more desirable to cache.
Cost, c: if a response is more expensive to generate (e.g., in terms of resources), then it is more desirable to cache the response.
Size, s: smaller responses are more desirable to cache.
Latency, 1: If the latency for receiving a response is higher, then it is more desirable to cache the response.

In various implementations, the system may compute a utility score for each query-response pair stored in the cached based on the aforementioned parameters. The utility score increases with parameters f, c, 1, and d and decreases with parameter s. A higher utility score for a query-response pair indicates that it is more desirable to retain that query-response pair. As described in the following sections of the disclosure, the techniques herein may utilize the semantic distance and the utility score to increase the diversity of content in the LLM cache.

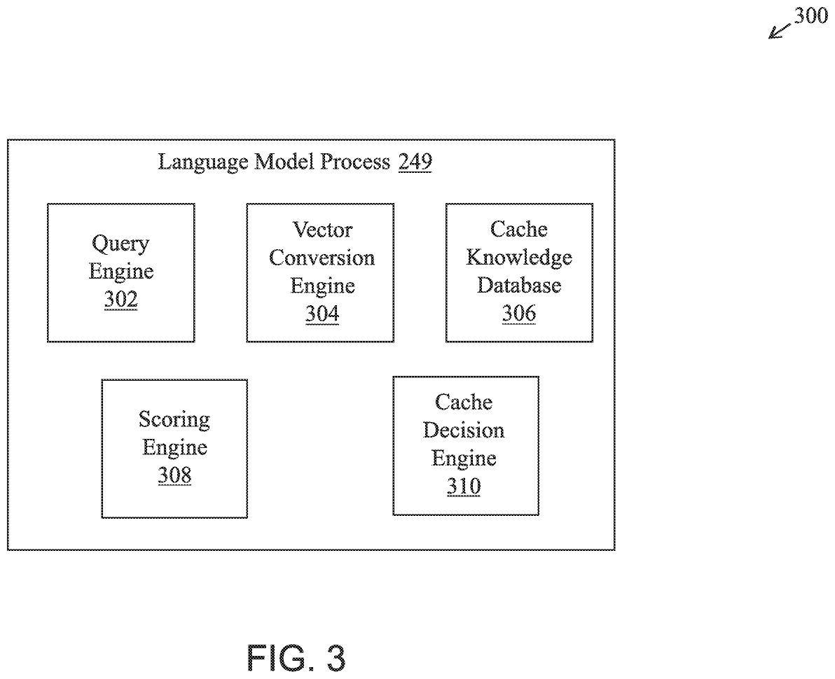

FIG. 3 illustrates an example architecture 300 for cache replacement using semantic diversity, according to various implementations. At the core of architecture 300 is language model process 249, which may be executed at a user device, a CE router, a PE router, a server, or another device in communication with. Language model process 249 may interface with a user device, either locally or via a network, such as via one or more application programming interfaces (APIs), etc. In addition, language model process 249 may communicate with any number of user interfaces.

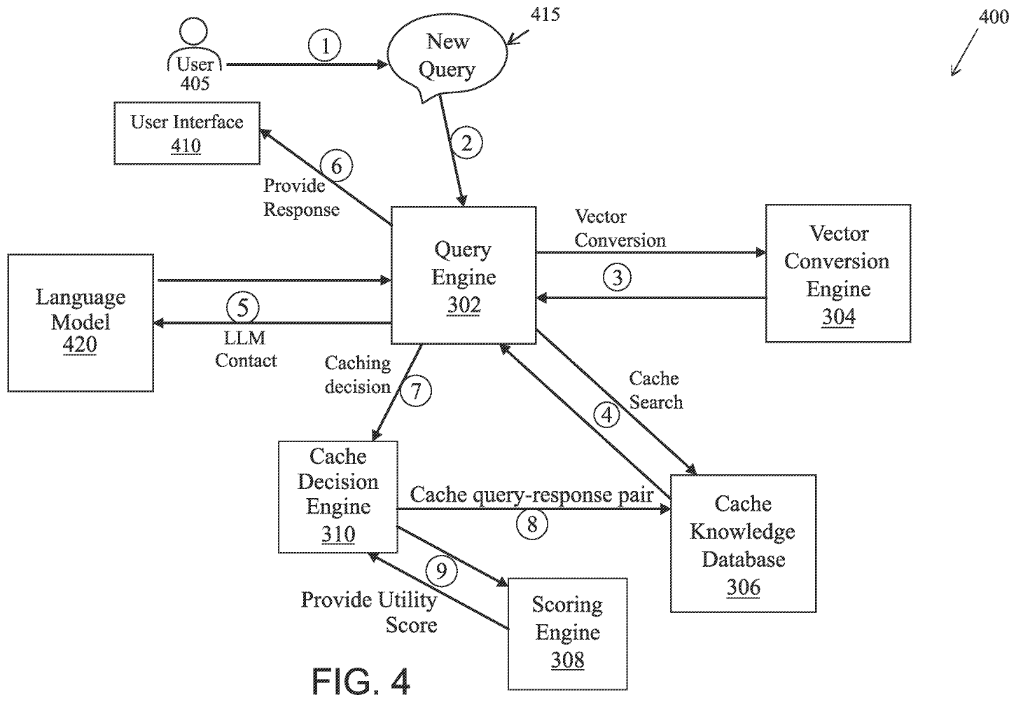

As shown, language model process 249 may include any or all of the following components: a query engine 302, a vector conversion engine 304, a cache knowledge database 306, a scoring engine 308, and/or a cache decision engine 310. As would be appreciated, the functionalities of these components may be combined or omitted, as desired. In addition, these components may be implemented on a singular device or in a distributed manner, in which case the combination of executing devices can be viewed as their own singular device for purposes of executing language model process 249. FIG. 4 illustrates an example 400 of the interactions of the components of architecture 300.

According to various implementations, query engine 302 may receive a query from a user or other source (e.g., an application, an agent, etc.), and perform one or more steps that can include retrieving a response from a LLM cache or sending the query to a language model, such as an LLM, for a response. In turn, query engine 302 may provide the retrieved response/answer, either from the cache or newly generated by the language mode, back to the issuer of the query.

In various implementations, vector conversion engine 304 may convert the query received from the user in a natural language to a vector. Vector conversion engine 304 may use a variety of different models to convert or to vectorize the query to a vector v1. Such models may include, but are not limited to proprietary models, publicly available models from organizations such as Hugging Face and OpenAI, and other open-source models, for instance.

According to various implementations, cache knowledge database 306 may take the form of a vector database or other database that has the role of storing the text contents of queries as vector embeddings and a corresponding response to each query as a query-response pair. Cache knowledge database 306 may facilitate semantic searches of stored query-response pairs. In some implementations, cache knowledge database 306 may leverage a vector database, such as Chroma or Pinecone, to achieve this role.

In various implementations, scoring engine 308 may determine a minimal semantic distance of each query-response pair of a plurality of query-response pairs stored in a cache. In one example, the minimal semantic distance is quantitatively determined as a semantic difference between natural language texts associated with queries. This can be done by converting natural language text to vectors and comparing the vectors to determine the semantic difference. In one example, cosine similarity is used for comparing vectors. Other methods for comparing vectors may include Dot product, Euclidean distance, Manhattan distance, Minkowski distance, etc.

While these methods may be fine if cache knowledge database 306 does not contain too many vectors, when there are many vectors, the one-to-one comparison may become inefficient. Indeed, the one-to-one comparison takes O(n) execution time where n is the number of cached query-answer pairs in cache knowledge database 306. Other more efficient ways exist for comparing vectors that query engine 302 could also use, and several are available as open-source libraries, such as Faiss and the like.

During its comparison, scoring engine 308 may identify, for a vector v1 corresponding to a query of a query-response pair, a most similar vector v2 stored in cache knowledge database 306. Scoring engine 308 then determines a minimum semantic distance as a semantic difference between the vector v1 and the vector v2. For a response r, d is the minimum semantic difference between the query corresponding to r and another query corresponding to the most similar vector v2.

In various implementations, scoring engine 308 may also assign a utility score u for each response or query-response pair. As discussed above, a higher utility score for a response indicates that it is more desirable to retain the response in the cache. The utility score u increases with parameters f, c, 1, and d and decreases with parameter s. Numerical weights wf, wc, wl, wd, and ws may be assigned to parameters f, c, l, d, and s respectively. These respective weights are correlated with an importance of parameters f, c, l, d, and s and can be assigned in some implementations by a user or an administrator. In some implementations, the respective weights for parameters f, c, l, d, and s can be modified by a computer based on run-time conditions. The utility score for each response is then determined based on the respective weights. In one implementation, the utility score is determined as:

u=(wf*f)*(wc*c)*(wl*l)*(wd*d)/(ws*s)

In another implementation, the utility score may be determined using the formula:

u=((wf*f)+(wc*c)+(wl*l)+(wd*d))/(ws*s)

Scoring engine 308 may also assign default values to some of these parameters when they are not known. In some other examples, scoring engine 308 may modify the computation of the utility score u so as to leave out one or more of these parameters. Note that leaving out a parameter can be achieved by assigning 0 to its weight.

In various implementations, cache decision engine 310 may be responsible for making caching decisions with respect to cache knowledge database 306, such as when to add new query-response pairs to it or remove a query-response pair from it. For instance, cache decision engine 310 may determine that cache knowledge database 306 should be pruned based on a size of the cache exceeding a threshold size. In some implementations, as detailed below, cache decision engine 310 may select a particular query-response pair from amongst the plurality of query-response pairs for pruning, based on that pair having a minimal semantic distance to another query-response pair stored in cache knowledge database 306. Cache decision engine 310 then prunes the particular query-response pair from the cache. In some implementations, cache decision engine 310 may also take into account the utility score u of each query-response pair, favoring removal of the pair with the least utility (and closest semantically to another entry).

FIG. 4 illustrates an example 400 of the interactions of the components of the architecture in FIG. 3. As shown, a user 405 may create a new query 415 via a user interface 410, as shown at (1). In further implementations, new query 415 may instead be generated automatically, such as by an application, agent, other language model, or the like. New query 415 is then sent from user interface 410 to query engine 302, as shown at (2). Typically, new query 415 may be in a natural language format, for example:
“What is a status of a router in computer network 100?”
“Explain how random forests can be used for regression and classification problems” or
“I need to perform regression and classification on certain data sets. I have heard that random forests are a potential approach. How can I apply random forests for what I am trying to do?”

At (3), query engine 302 may then send new query 415 to vector conversion engine 304 to convert it from natural language format in a vector v1 that represents its textual contents. As discussed above, vector conversion engine 304 may use a variety of different models to convert new query 415 to the vector v1. An example may include the Facebook Contriever MSMARCO model. In turn, vector conversion engine 304 may return vector v1 that represents new query 415 to query engine 302.

At (4), query engine 302 may then perform a search in cache knowledge database 306 for the vector v1 to identify a cached query associated with a vector v2 that is similar to vector v1 based on a semantic similarity threshold. One example method for doing so may be to compare the vector v1 to all vectors stored in cache knowledge database 306. During this comparison, query engine 302 may identify a most similar vector v2 stored in cache knowledge database 306. Query engine 302 may then determine whether a semantic similarity between the vector v1 and a vector v2 exceeds a semantic similarity threshold. If the answer is yes, then query engine 310 may simply return the cached answer associated with vector v2 as the answer/response to new query 415, which is then presented to user 405 via user interface 410.

Conversely, if the semantic similarity between the vector v1 and a vector v2 does not exceed the semantic similarity threshold, then query engine 302 may send new query 415 to language model 420 (or a set of language models) to obtain a new answer/response, as shown at (5). In turn, query engine 302 may return the new response to user interface 410 for presentation to user 405 via user interface 410.

In cases in which query engine 302 sends new query 415 to language model 420 for resolution (e.g., because of a lack of a cache hit in cache knowledge database 306), query engine 302 may then send new query 415 and its corresponding answer/response from language model 420 to cache decision engine 310 for evaluation, at (7). More specifically, cache decision engine 310 may determine whether new query 415 and its corresponding response should be cached in cache knowledge database 306.

In some implementations, for caching the new query-response pair, cache decision engine 310 may determine whether there is sufficient space in the cache of cache knowledge database 306. For example, cache decision engine 310 may determine whether a current size of the cache is greater than a threshold size. In one implementation, if there is sufficient space (e.g., the current size is lower than the threshold), cache decision engine 310 may simply opt to cache the query-response pair as a new entry in cache knowledge database 306, at (8). In doing so, if user 405 or another user then issues the same, or a sufficiently similar query, to that of new query 415, query engine 302 can simply retrieve its answer from cache knowledge database 306.

In further implementations, if there is not sufficient space in cache knowledge database 306 (e.g., its current size is equal to, or exceeds, the threshold), cache decision engine 310 may initiate cache pruning of cache knowledge database 306, to make room for the new query-response pair that includes new query 415, before storing it. To do so, cache decision engine 310 may interact with scoring engine 308, to assign scores to the entries in cache knowledge database 306, at (9).

In some implementations, scoring engine 308 may assess the entries in cache knowledge database 306, to determine the semantic distances between the entries. For each cached pair, scoring engine 308 may then identify its shortest semantic distance (e.g., the parameter d above) and notify cache decision engine 310. In turn, cache decision engine 310 may then select one or more of the entries in cache knowledge database 306 for pruning, based on that entry or entries having a lowest value of d. In doing so, cache decision engine 310 may optimize cache knowledge database 306 such that its stored query-response pairs are more dissimilar, thereby avoiding caching redundant pairs with the same or similar answers/responses.

Scoring engine 308 may also, in some cases, compute a utility score for each of the entries in cache knowledge database 306 that cache decision engine 310 may consider when selecting which entry or entries in cache knowledge database 306 to prune (i.e., delete). As noted above, such a utility score can take into account additional factors such as, but not limited to, a frequency at which that entry was accessed from cache knowledge database 306, a cost associated with re-running a given query stored in cache knowledge database 306, a size of a response stored in cache knowledge database 306, a latency associated with re-running a given query, or the like. In some instances, scoring engine 308 may also weight these factors and/or the smallest semantic distance for each cached pair, as desired (e.g., an administrator may specify the weights via a user interface).

Thus, in some instances, cache decision engine 310 may simply prune an existing query-response pair from cache knowledge database 306, if it has the shortest semantic distance to another pair in cache knowledge database 306. However, further implementations provide for cache decision engine 310 to not only consider the semantic distances between pairs in cache knowledge database 306, but also take into account other factors, as well. For instance, cache decision engine 310 may opt to retain two pairs that have the smallest semantic distance in cache knowledge database 306, instead pruning another pair that is slightly farther away from its closest pair but is rarely accessed by query engine 302.

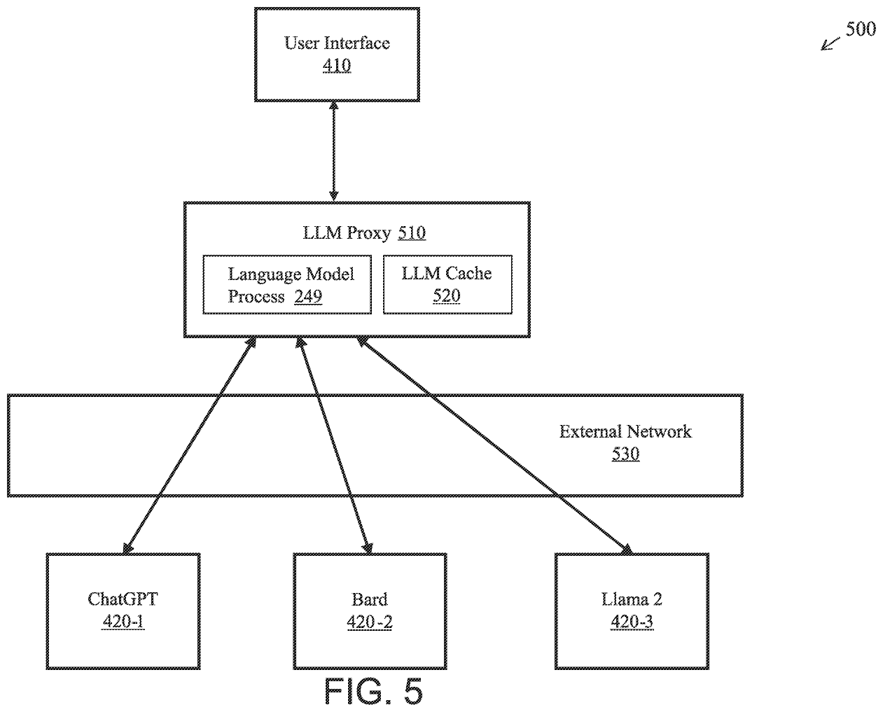

FIG. 5 illustrates an example operating environment 500 for cache replacement using semantic diversity, according to various implementations, in accordance with one or more implementations described herein. As shown, operating environment 500 includes user interface 410, a LLM proxy 510, an external network 530, and a plurality of LLMs, that is, ChatGPT 420-1, Bard 420-2, and Llama 2 420-3. Although only three LLMs are shown, operating environment 500 may include a different number of LLMs. LLM proxy 510 may include language model process 249 and an LLM cache 520.

User interface 410 may be provided on a user device, for example, one or more of nodes/device 10-20. As discussed above, user 405 may create new query 415 on user interface 410. New query 415 is received by LLM proxy 510. LLM proxy 510 may be provided on any of nodes/device 10-20, CE routers 110, and PE routers 120. LLM proxy 510, using language process model 429, may convert new query 415 to the vector v1 and perform a search in LLM cache 520 to determine a cached query that is associated with a vector v2 that is most similar to vector v1. LLM proxy 510 determines whether a semantic similarity between the vector v1 and the vector v2 exceeds the semantic similarity threshold. If the answer is yes, then LLM proxy 510 returns the cached answer corresponding to new query 415 to user interface 410. If the semantic similarity between the vector v1 and the vector v2 does not exceed the semantic similarity threshold, then LLM proxy 510 contacts at least one of the plurality of LLMs (that is, ChatGPT 420-1, Bard 420-2, or Llama 2 420-3) over external network 530.

LLM proxy 510 may be able to contact one or more of the plurality of LLMs through external network 530 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. External network 530 may include the public Internet, a multiprotocol label switching (MPLS) virtual private network (VPN), or the like.

LLM proxy 510 receives a response for new query 415 from one or more of the plurality of LLMs (that is, ChatGPT 420-1, Bard 420-2, or Llama 2 420-3). LLM proxy 510 provides the received response to user interface 410 to satisfy new query 415. As described herein, LLM proxy 510 may cache the response for new query 415 received from one or more of the plurality of LLMs in LLM cache 520.

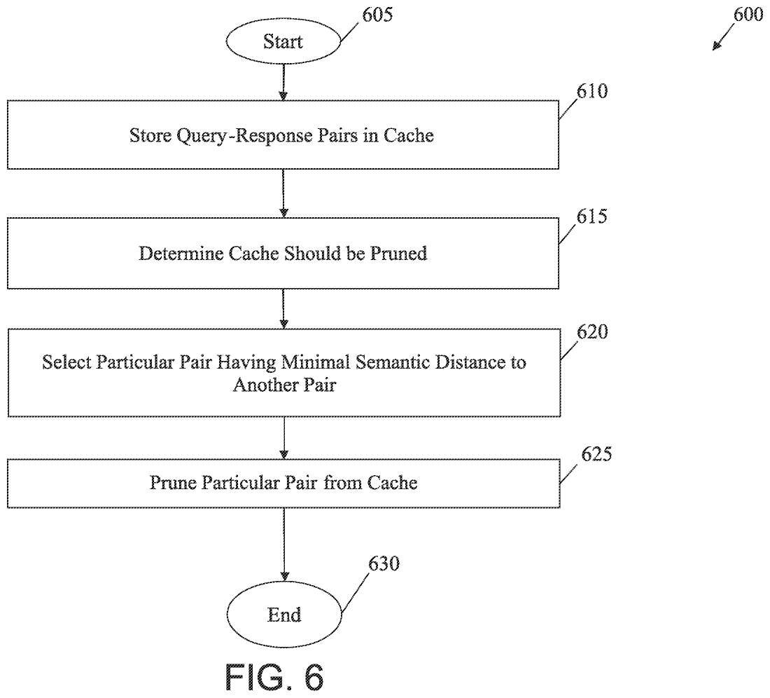

FIG. 6 illustrates an example simplified procedure (e.g., a method) for cache replacement for text data using semantic diversity, in accordance with one or more implementations described herein. For example, a non-generic, specifically configured device (e.g., device 200), such as a router, firewall, controller for a network (e.g., an SDN controller or other device in communication therewith), server, or the like, may perform procedure 600 by executing stored instructions (e.g., language model process 249). The procedure 600 may start at step 605, and continues to step 610, where, as described in greater detail above, the device may store, in a cache, a plurality of query-response pairs of queries issued to a language model and their corresponding answers from the language model. In some instances, the language model is an LLM. In some cases, the device may also search the cache to match a new query for input to the language model to an existing query in the cache and provide a response associated with the existing query as a response to the new query, in lieu of inputting the new query to the language model. In another implementation, the device may send a new query for input to the language model, when the new query does not match any queries in the cache.

At step 615, as detailed above, the device may determine that the cache should be pruned based on a size of the cache exceeding a threshold size.

At step 620, the device may select a particular query-response pair from amongst the plurality of query-response pairs based on that pair having a minimal semantic distance to another query-response pair in the plurality of query-response pairs, as described in greater detail above. In some implementations, the device selects the particular query-response pair from amongst the plurality of query-response pairs further based on a frequency of access of each of the plurality of query-response pairs. In a further implementation, the device selects the particular query-response pair from amongst the plurality of query-response pairs based further on a cost associated with the particular query-response pair. In yet another implementation, the device selects the particular query-response pair from amongst the plurality of query-response pairs based further on a latency associated with re-generating the particular query-response pair using the language model. In some cases, the device may make the selection by computing a utility score for the particular query-response pair that weights its minimal semantic distance to another query-response pair in the plurality of query-response pairs. In a further implementation, the device selects the particular query-response pair from amongst the plurality of query-response pairs based further on a size of the query-response pair in the cache. In another implementation, the device may make the selection in part by computing a vector corresponding to the particular query-response pair and a vector corresponding to a second query-response pair in the cache and determining a semantic similarity between the particular query-response pair and the second query-response pair by comparing their corresponding vectors.

At step 625, as detailed above, the device may prune the particular query-response pair from the cache. In various implementations, the device prunes the particular query-response pair from the cache to free up storage space for storage of a new query-response pair.

Procedure 600 then ends at step 630.

While there have been shown and described illustrative implementations that provide for cache replacement for text data using semantic diversity, it is to be understood that various other adaptations and modifications may be made within the spirit and scope of the implementations herein. For example, while certain implementations are described herein with respect to using a caching mechanism for LLMs, other language models could also be used, as desired. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
storing, by a device and in a cache, a plurality of query-response pairs of queries issued to a language model and their corresponding answers from the language model;
determining, by the device, that the cache should be pruned based on a size of the cache exceeding a threshold size;
selecting, by the device, a particular query-response pair from amongst the plurality of query-response pairs based on that pair having a minimal semantic distance to another query-response pair in the plurality of query-response pairs; and
pruning, by the device, the particular query-response pair from the cache.

2. The method as in claim 1, wherein the device selects the particular query-response pair from amongst the plurality of query-response pairs further based on a frequency of access of each of the plurality of query-response pairs.

3. The method as in claim 1, wherein the device selects the particular query-response pair from amongst the plurality of query-response pairs based further on a cost associated with the particular query-response pair.

4. The method as in claim 1, wherein the device selects the particular query-response pair from amongst the plurality of query-response pairs based further on a latency associated with re-generating the particular query-response pair using the language model.

5. The method as in claim 1, wherein the device prunes the particular query-response pair from the cache to free up storage space for storage of a new query-response pair.

6. The method as in claim 1, wherein selecting the particular query-response pair from amongst the plurality of query-response pairs further comprises:
computing a utility score for the particular query-response pair that weights its minimal semantic distance to another query-response pair in the plurality of query-response pairs.

7. The method as in claim 1, wherein the device selects the particular query-response pair from amongst the plurality of query-response pairs based further on a size of the query-response pair in the cache.

8. The method as in claim 1, further comprising:
searching the cache to match a new query for input to the language model to an existing query in the cache, and
providing a response associated with the existing query as a response to the new query, in lieu of inputting the new query to the language model.

9. The method as in claim 1, further comprising:
sending a new query for input to the language model, when the new query does not match any queries in the cache.

10. The method as in claim 1, wherein the language model is a large language model (LLM).

11. The method as in claim 1, wherein the device selects the particular query-response pair by:
computing a vector corresponding to the particular query-response pair and a vector corresponding to a second query-response pair in the cache; and
determining a semantic similarity between the particular query-response pair and the second query-response pair by comparing their corresponding vectors.

12. An apparatus, comprising:
one or more network interfaces;
a processor coupled to the one or more network interfaces and configured to execute one or more processes; and
a memory configured to store a process that is executable by the processor, the process when executed configured to:
store, in a cache, a plurality of query-response pairs of queries issued to a language model and their corresponding answers from the language model;
determine that the cache should be pruned based on a size of the cache exceeding a threshold size;
select a particular query-response pair from amongst the plurality of query-response pairs based on that pair having a minimal semantic distance to another query-response pair in the plurality of query-response pairs; and
prune the particular query-response pair from the cache.

13. The apparatus as in claim 12, wherein the apparatus selects the particular query-response pair from amongst the plurality of query-response pairs further based on a frequency of access of each of the plurality of query-response pairs.

14. The apparatus as in claim 12, wherein the apparatus selects the particular query-response pair from amongst the plurality of query-response pairs based further on a cost associated with the particular query-response pair.

15. The apparatus as in claim 12, wherein the apparatus selects the particular query-response pair from amongst the plurality of query-response pairs based further on a latency associated with re-generating the particular query-response pair using the language model.

16. The apparatus as in claim 12, wherein the apparatus prunes the particular query-response pair from the cache to free up storage space for storage of a new query-response pair.

17. The apparatus as in claim 12, wherein the apparatus selects the particular query-response pair from amongst the plurality of query-response pairs further by:
computing a utility score for the particular query-response pair that weights its minimal semantic distance to another query-response pair in the plurality of query-response pairs.

18. The apparatus as in claim 12, wherein the apparatus selects the particular query-response pair from amongst the plurality of query-response pairs based further on a size of the query-response pair in the cache.

19. The apparatus as in claim 12, wherein the process when executed is further configured to:
search the cache to match a new query for input to the language model to an existing query in the cache, and
provide a response associated with the existing query as a response to the new query, in lieu of inputting the new query to the language model.

20. A tangible, non-transitory, computer-readable medium storing program instructions that cause a device to execute a process comprising:
storing, by a device and in a cache, a plurality of query-response pairs of queries issued to a language model and their corresponding answers from the language model;
determining, by the device, that the cache should be pruned based on a size of the cache exceeding a threshold size;
selecting, by the device, a particular query-response pair from amongst the plurality of query-response pairs based on that pair having a minimal semantic distance to another query-response pair in the plurality of query-response pairs; and
pruning, by the device, the particular query-response pair from the cache.
